(19) United States
(12) Patent Application Publication
(10) Pub. No.: US 2005/0242170 A1
(43) Pub. Date: Nov. 3, 2005

(54) Prepaid long-distance telephone calling card with separable coupon

(75) Inventor: Elie Seidman, New York, NY (US)

Correspondence Address: OPPEDAHL AND LARSON LLP, P O BOX 5068, DILLON, CO, 80435-5068, US

(73) Assignee: EPANA NETWORKS, INC., New York, NY (US)

(21) Appl. No.: 10/709,396

(22) Filed: May 1, 2004

(51) Int. Cl. G06K 5/00

(52) U.S. Cl. 235/380

(57) ABSTRACT

An instrument has a perforation joining a first portion and a second portion, each of the first card and second card having an obverse and a reverse side. The first portion bears on both its obverse and reverse sides indicia relating to a store coupon of a first predetermined value, and may have greater surface area than the second portion. The second portion has on both its obverse and reverse sides indicia relating to a prepaid long-distance telephone calling card, has on its obverse indicia relating to a prepaid amount in a second predetermined value, and has on its reverse side a PIN code and a toll-free access telephone number.

### BACKGROUND

An enormous amount of effort has been expended in recent years to attempt to devise effective and efficient ways to sell and to promote products and to sell and to promote prepaid long-distance telephone calling cards.

A number of approaches to selling and to promoting products and to selling and to promoting prepaid long-distance telephone calling cards, among them U.S. Pat. No. 5,489,123 to Roshkoff; U.S. Pat. No. 5,537,314 to Kanter; U.S. Pat. No. 5,720,500 to Okazaki et al.; U.S. Pat. No. 5,749,075 to Toader et al.; U.S. Pat. No. 5,915,007 to Klapka; U.S. Pat. No. 5,992,731 to Tani; U.S. Pat. No. 6,183,017 to Najor et al.; and U.S. Pat. No. 6,615,190 to Slater; US patent publications 20020190121 to Walker et al. and 20030070338 to Roshkoff; and PCT publication WO 96-31848 to Burdon et al.

None of these approaches is completely satisfactory. The card of U.S. Pat. No. 6,183,017 to Najor et al., for example, is small and thus is all too easy to shoplift, and in many cases it is impossible to fit onto the card all of the indicia which would need to be present if the card were to serve its intended purpose of both a prepaid long-distance telephone calling card and a store coupon. Another problem with this card is that a would-be purchaser cannot redeem the store coupon at a convenient time but must instead postpone the redemption until after the prepaid calling-card value is consumed, or will lose some or all of the prepaid value.

Even in the face of these problems, a satisfactory approach has not heretofore been devised that achieves the many conflicting goals facing the designers of such cards.

There is thus a need for an approach for a prepaid long-distance telephone calling card which also offers in some way the promotional benefit of a store coupon, while being difficult to shop-life and while somehow being readily displayed for potential purchase and presenting an immediately redeemable coupon.

### SUMMARY

An instrument has a perforation joining a first portion and a second portion, each of the first card and second card having an obverse and a reverse side. The first portion bears on both its obverse and reverse sides indicia relating to a store coupon of a first predetermined value, and may have greater surface area than the second portion. The second portion has on both its obverse and reverse sides indicia relating to a prepaid long-distance telephone calling card, has on its obverse indicia relating to a prepaid amount in a second predetermined value, and has on its reverse side a PIN code and a toll-free access telephone number.

### DESCRIPTION OF THE DRAWING

The invention will be described with respect to a drawing in several figures.

FIG. 1 is a plan view of the obverse side of a first exemplary instrument according to the invention.

FIG. 2 is a plan view of the reverse side of a first exemplary instrument according to the invention.

FIG. 3 shows a process of purchase, separation, and redemption and use of the exemplary instrument of FIGS. 1 and 2.

FIG. 4 shows instruments according to the invention hanging from a hook.

FIG. 5 shows instruments according to the invention placed in a display rack.

FIG. 6 is a plan view of the obverse side of a second exemplary instrument according to the invention.

FIG. 7 is a plan view of the reverse side of a second exemplary instrument according to the invention.

FIG. 8 is a plan view of an outer jacket forming part of a third exemplary instrument according to the invention.

FIG. 9 is a cross-section of the third exemplary instrument of which the jacket of FIG. 8 forms a part.

Where possible, like reference designations have been employed in the figures to denote like features.

### DETAILED DESCRIPTION

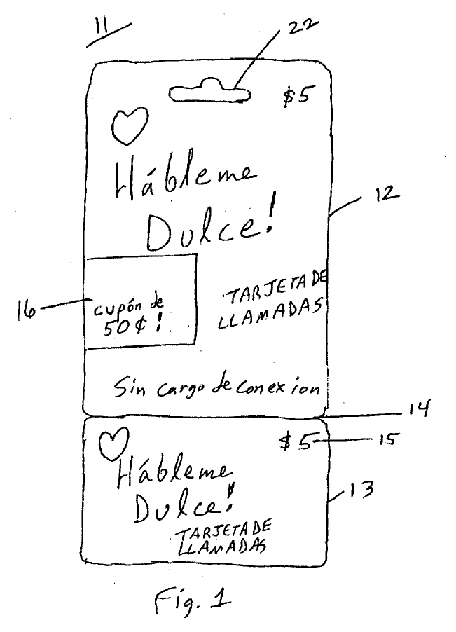

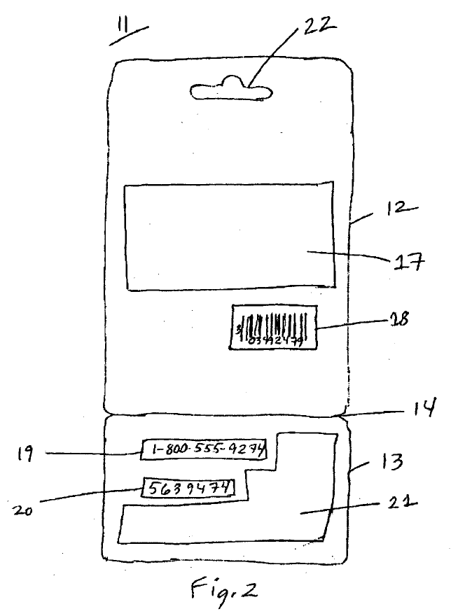

Turning first to FIGS. 1 and 2, what is shown are plan views of the obverse and reverse sides, respectively, of an exemplary instrument 11. The instrument 11 has a perforation 14 joining a first card 12 and a second card 13, each of said first card 12 and second card 13 having an obverse and a reverse side shown in FIGS. 1 and 2 respectively. The first card 12 has a hook opening 22 and bears on both its obverse and reverse sides indicia 16 and 17 relating to a store coupon of a first predetermined value. The first card 12 has greater surface area than the second card 13. The second card 13 has on both its obverse and reverse sides indicia 15, 19, 20 relating to a prepaid long-distance telephone calling card. The second card 13 has on its obverse indicia 15 relating to a prepaid amount in a second predetermined value. The second card 13 has on its reverse side a PIN code 20 and a toll-free access telephone number 19. The first card 12 may also bear a bar code 18 on its reverse, which bar code may be used in bar-code scanning for purposes of redemption of the coupon value. The second card 13 preferably bears detailed information 21 which explains the use of the second card 13 for placing prepaid long-distance telephone calls.

In a typical embodiment, the first card 12 has more than double the surface area of the second card 13. This makes the instrument 11 large enough that it is difficult to shoplift.

In this particular illustrative embodiment, the card name “hábleme dulce” means “speak sweetly to me.” “Sin cargo de conexion” means “without a connection charge.” “Tarjeta de llamadas” means “calling card.” “Cupón de 50¢” means “50¢ coupon.”

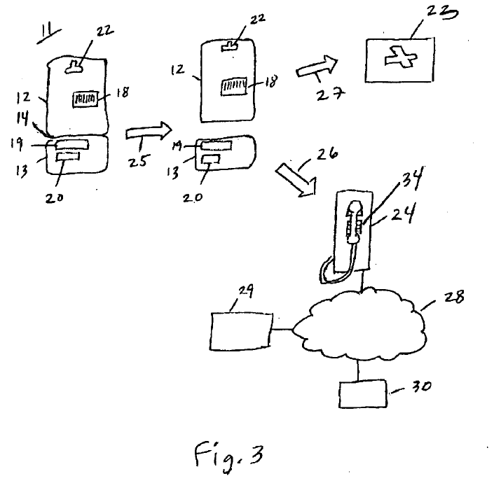

FIG. 3 shows a process of purchase, separation, and redemption and use of the exemplary instrument 11. At an early stage of the process, the instrument 11 is as described above. In step 25, the first card 12 is separated from the second card 13 at the perforation 14. This separating step is preferably done by hand rather than by means of machinery or cutting devices.

At step 27, the first card 12 is redeemed for its first predetermined value in a purchase after the separating step 25. In some redemption processes, the bar code 18 is passed over a bar code scanner 23. In this way the bar code 18 is scanned on the bar code scanner 23. Typically the bar code 18 is a UPC code (uniform or universal product code) formatted so as to communicate by means of the scanner the value of the coupon, as well as the expiration date and in some cases, information used to check to see whether the purchaser actually purchased the item for which the coupon is to be redeemed.

At step 26, at least one long-distance telephone call is placed for no greater than any unused portion of the second predetermined value. In a typical sequence of events, the user dials the toll-free access telephone number 19 at a keypad 34 of a telephone 24. After the toll-free access telephone number 19 is dialed, the user the enters the PIN code 20 and a destination telephone number at the keypad 34. In an exemplary embodiment the keypad 34 emits dual-tone multifrequency (DTMF) tones.

Another exemplary embodiment is termed the “PIN-less” calling card. With such a card, the user goes to a landline telephone and dials a sequence of digits as instructed on the card. The service provider uses ANI to identify the calling line, and connects the long-distance call until the prepaid value is exhausted.

The telephone call at the telephone 24 passes through the public switched telephone network 28 to server 29. Server 29 determines the amount of unused portion (if any) of the second predetermined value. If there is unused value associated with the card 13, then the voice path of the telephone call is connected to destination 30. In a commonplace sequence of events, the telephone call does not exhaust the prepaid value, and the holder of the card 13 may place additional telephone calls until that value is exhausted.

One example of how calls may be completed is that destination 30 may be in a different country than the telephone 24, and the link from server 29 to destination 30 may be provided, at least in part, by means of voice over Internet Protocol (VOIP).

In an exemplary sequence of events, the redeeming step 27 is performed prior to performing the placing step 26. This is desirable from the point of view of the purchaser because the purchaser may wish to redeem the coupon of the card 12 right away. The coupon may, for example, be near its expiration date. In a prior-art arrangement such as that described in the above-mentioned patent to Najor et al, the purchaser will be forced to postpone redeeming the coupon until the prepaid value of the calling card is exhausted (on paid of losing value of the card), but this might be after the expiration date of the coupon, leading to dissatisfaction for the purchaser.

From the point of view of the couponer this may be disadvantageous. The couponer risks that the purchaser may forget to use the coupon or that the coupon may expire before the card value is exhausted, and in either case the opportunity to sell the coupon-related product is lost. The couponer may also face a negative reaction by the purchaser who may resent not being able to use the coupon right away.

It will also be appreciated that whenever a prepaid long-distance telephone calling card has associated with it a detachable portion that is intended to make shoplifting more difficult, the detachable portion must be disposed of in some way. In prior-art arrangements the detachable portion has no use after being detached and might be discarded hastily, giving rise to litter. In the present arrangement, however, the detachable portion has value as a store coupon and this will likely lead to more careful handling, thus reducing the risk of litter.

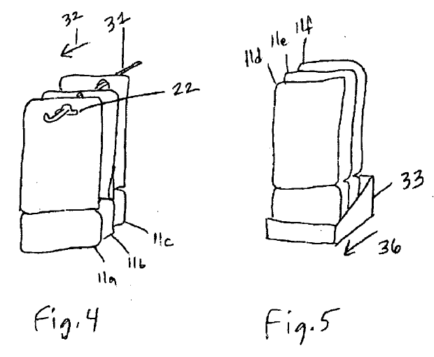

FIG. 4 shows instruments 11a, 11b, 11c, hanging from a hook 31. To bring about this result, the instrument 11c is hung on the hook 31. After this, another instrument 11b is hung on the hook 31. After this, yet another instrument 11a is hung on the hook 31. It is noted that in FIG. 4, the hook 31 protrudes in a first direction 32, toward potential purchasers. Each instrument 11a, 11b, 11c hangs from the hook 31 by its hook opening 22. The obverse of each instrument 11a, 11b, 11c preferably faces in the first direction 32. The obverse faces of the instruments 11a, 11b, and 11c are designed to sell the instruments, with large and easy-to-read legends. In contrast some of the writing on the reverse faces of the instruments 11a, 11b, 11c can be small as it is important to the purchaser only after purchase.

At the time of a purchase of an instrument 11a, first the instrument 11a is removed from the hook 31.

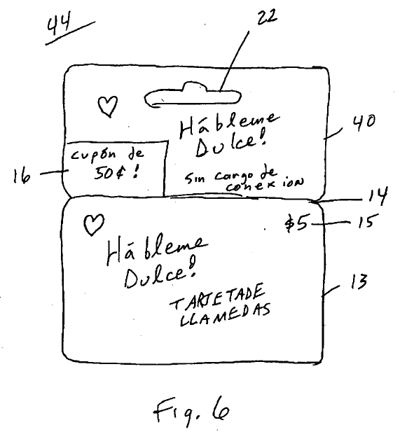

FIG. 5 shows instruments 11d, 11e, 11f placed in a display rack 33. The rack 33 defines a first direction 36 toward potential purchasers. The obverse of each instrument 11d, 11e, 11f faces in the first direction 36. In a typical sequence of events, a first one 11f of the instruments is placed in the rack 33. Next a second one 11e of the instruments is placed in the rack 33.

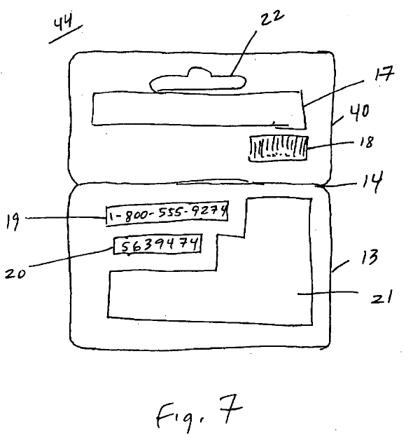

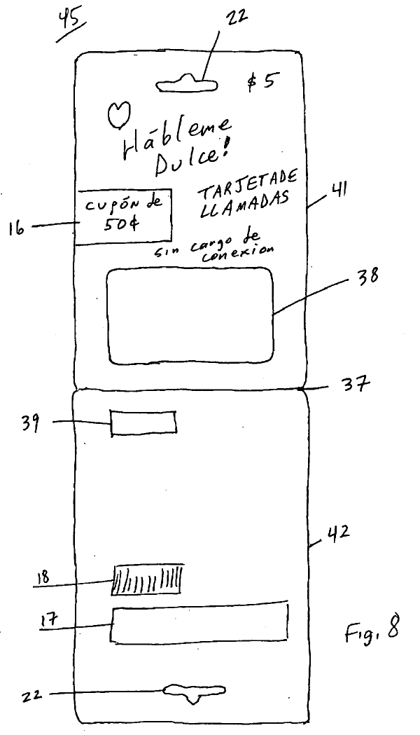

FIGS. 6 and 7 show plan views of the obverse and reverse sides, respectively, of an exemplary instrument 44. The instrument 44 has a perforation 14 joining a first card 40 and a second card 13, each of said first card 40 and second card 13 having an obverse and a reverse side shown in FIGS. 6 and 7 respectively. The first card 40 has a hook opening 22 and bears on both its obverse and reverse sides indicia 16 and 17 relating to a store coupon of a first predetermined value. The second card 13 has on both its obverse and reverse sides indicia 15, 19, 20 relating to a prepaid long-distance telephone calling card. The second card 13 has on its obverse indicia 15 relating to a prepaid amount in a second predetermined value. The second card 13 has on its reverse side a PIN code 20 and a toll-free access telephone number 19. The first card 40 may also bear a bar code 18 on its reverse, which bar code is used in bar-code scanning for purposes of redemption of the coupon value. The second card 13 preferably bears detailed information 21 which explains the use of the second card 13 for placing prepaid long-distance telephone calls.

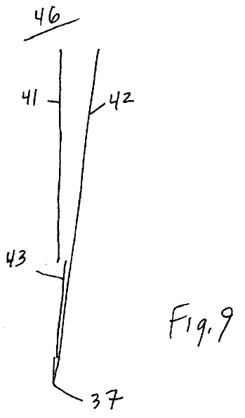

FIG. 8 is a plan view of an outer jacket 45 forming part of a third exemplary instrument 46 (shown in FIG. 9) according to the invention. Jacket portion 41 represents the obverse of the assembled instrument 46, while jacket portion 42 represents the reverse of the assembled instrument 46. Each of jacket portions 41, 42 has a hook opening 22, and the hook openings 22 line up when the jacket 45 is folded at fold line 37. Jacket portion 41 bears indicia 16 and and the jacket portion 42 bears indicia 17 relating to a store coupon of a first predetermined value. The jacket portion 42 may also bear a bar code 18 which bar code may be used in bar-code scanning for purposes of redemption of the coupon value. A clear window area 38 is provided in front portion 41 through which the obverse of a prepaid long-distance telephone calling card (omitted for clarity in FIG. 8) may be seen. A clear window area 39 may be provided in rear portion 42 through which a tracking number, printed on the reverse of the prepaid long-distance telephone calling card may be seen.

FIG. 9 is a cross-section of the third exemplary instrument 46 of which the jacket 45 (FIG. 8) forms a part. Front portion 41 is seen edgewise, as is rear portion 42, connected at fold line 37. A prepaid long-distance telephone calling card 43 is seen, positioned between first and second portions 41, 42. The first and second portions are glued together to yield the assembled instrument 46.

The calling card 43 has on both its obverse and reverse sides indicia relating to a prepaid long-distance telephone calling card. The calling card 43 has on its obverse indicia relating to a prepaid amount in a second predetermined value. The calling card 43 has on its reverse side a PIN code and a toll-free access telephone number. The calling card 43 preferably bears detailed information which explains the use of the second card 43 for placing prepaid long-distance telephone calls. The indicia on the obverse and reverse of the card 43 are preferably similar to or identical to the indicia shown in FIGS. 1 and 2 or the card 13.

Those skilled in the art will have no difficulty devising myriad obvious improvements and enhancements to the invention, none of which depart from the invention and all of which are intended to be encompassed by the claims which follow.

1. A method performed with respect to an instrument, the instrument having a perforation joining a first card and a second card, each of said first card and second card having an obverse and a reverse side, the first card having a hook opening and bearing on both its obverse and reverse sides indicia relating to a store coupon of a first predetermined value, the first card having greater surface area than the second card, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number; the method comprising the steps of:
hanging the instrument on a hook;
removing the instrument from the hook;
separating the first card from the second card at the perforation;
redeeming the first card for its first predetermined value in a purchase after the separating step; and
placing at least one long-distance telephone call for no greater than any unused portion of the second predetermined value;
the placing step further comprising dialing the toll-free access telephone number, and after the toll-free access telephone number is dialed, entering via dual-tone multifrequency tones the PIN code and a destination telephone number.

2. The method of claim 1 wherein the first card further comprises on its reverse a bar code relating to the first predetermined value, and wherein the step of redeeming the first card for its first predetermined value further comprises scanning the bar code on a bar code scanner.

3. The method of claim 1 wherein the placing step is performed more than once.

4. The method of claim 1 wherein the redeeming step is performed prior to performing the placing step.

5. Apparatus comprising an instrument, the instrument having a perforation joining a first card and a second card, each of said first card and second card having an obverse and a reverse side, the first card having a hook opening and bearing on both its obverse and reverse sides indicia relating to a store coupon of a first predetermined value, the first card having greater surface area than the second card, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number.

6. The apparatus of claim 5 wherein the first card has more than double the surface area of the second card.

7. An assembly comprising:
a hook protruding in a first direction; and
a plurality of instruments, each instrument having a perforation joining a first card and a second card, each of said first card and second card having an obverse and a reverse side, the first card having a hook opening and bearing on both its obverse and reverse sides indicia relating to a store coupon of a first predetermined value, the first card having greater surface area than the second card, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number;
wherein each instrument is hanging from the hook by its hook opening, and
wherein the obverse of each instrument faces in the first direction.

8. The assembly of claim 7 wherein, for each instrument, the first card has more than double the surface area of the second card.

9. A method performed with respect to a hook protruding in a first direction;
and a plurality of instruments, each instrument having a perforation joining a first card and a second card, each of said first card and second card having an obverse and a reverse side, the first card having a hook opening and bearing on both its obverse and reverse sides indicia relating to a store coupon of a first predetermined value, the first card having greater surface area than the second card, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number; the method comprising the steps of:
hanging a first one of the instruments on the hook by its hook opening, the instrument's obverse facing in the first direction; and
hanging a second one of the instruments on the hook by its hook opening, the instrument's obverse also facing in the first direction.

10. A method performed with respect to an instrument, the instrument having a perforation joining a first card and a second card, each of said first card and second card having an obverse and a reverse side, the first card bearing on both its obverse and reverse sides indicia relating to a store coupon of a first predetermined value, the first card having greater surface area than the second card, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number; the method comprising the steps of:
purchasing the instrument;
separating the first card from the second card at the perforation after purchase;
redeeming the first card for its first predetermined value in a purchase after the separating step; and
placing at least one long-distance telephone call for no greater than any unused portion of the second predetermined value;
the placing step further comprising dialing the toll-free access telephone number, and after the toll-free access telephone number is dialed, entering via dual-tone multifrequency tones the PIN code and a destination telephone number.

11. The method of claim 10 wherein the first card further comprises on its reverse a bar code relating to the first predetermined value, and wherein the step of redeeming the first card for its first predetermined value further comprises scanning the bar code on a bar code scanner.

12. The method of claim 10 wherein the placing step is performed more than once.

13. The method of claim 10 wherein the redeeming step is performed prior to performing the placing step.

14. Apparatus comprising an instrument, the instrument having a perforation joining a first card and a second card, each of said first card and second card having an obverse and a reverse side, the first card bearing on both its obverse and reverse sides indicia relating to a store coupon of a first predetermined value, the first card having greater surface area than the second card, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number.

15. The apparatus of claim 14 wherein the first card has more than double the surface area of the second card.

16. An assembly comprising:
a rack defining a first direction; and
a plurality of instruments, each instrument having a perforation joining a first card and a second card, each of said first card and second card having an obverse and a reverse side, the first card bearing on both its obverse and reverse sides indicia relating to a store coupon of a first predetermined value, the first card having greater surface area than the second card, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number;
wherein each instrument is contained in the rack, and
wherein the obverse of each instrument faces in the first direction.

17. The assembly of claim 16 wherein, for each instrument, the first card has more than double the surface area of the second card.

18. A method performed with respect to a rack defining a first direction; and a plurality of instruments, each instrument having a perforation joining a first card and a second card, each of said first card and second card having an obverse and a reverse side, the first card bearing on both its obverse and reverse sides indicia relating to a store coupon of a first predetermined value, the first card having greater surface area than the second card, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number; the method comprising the steps of:
placing a first one of the instruments in the rack, the instrument's obverse facing in the first direction; and
placing a second one of the instruments in the rack, the instrument's obverse also facing in the first direction.

19. A method performed with respect to an instrument, the instrument having a perforation joining a first card and a second card, each of said first card and second card having an obverse and a reverse side, the first card having a hook opening and bearing on both its obverse and reverse sides indicia relating to a store coupon of a first predetermined value, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number; the method comprising the steps of:
hanging the instrument on a hook;
removing the instrument from the hook;
separating the first card from the second card at the perforation;
redeeming the first card for its first predetermined value in a purchase after the separating step; and
placing at least one long-distance telephone call for no greater than any unused portion of the second predetermined value;
the placing step further comprising dialing the toll-free access telephone number, and after the toll-free access telephone number is dialed, entering via dual-tone multifrequency tones the PIN code and a destination telephone number.

20. The method of claim 19 wherein the first card further comprises on its reverse a bar code relating to the first predetermined value, and wherein the step of redeeming the first card for its first predetermined value further comprises scanning the bar code on a bar code scanner.

21. The method of claim 19 wherein the placing step is performed more than once.

22. The method of claim 1 wherein the redeeming step is performed prior to performing the placing step.

23. Apparatus comprising an instrument, the instrument having a perforation joining a first card and a second card, each of said first card and second card having an obverse and a reverse side, the first card having a hook opening and bearing on both its obverse and reverse sides indicia relating to a store coupon of a first predetermined value, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number.

24. The apparatus of claim 23 wherein the first card has greater surface area than the second card.

25. The apparatus of claim 24 wherein the first card has more than double the surface area of the second card.

26. An assembly comprising:
a hook protruding in a first direction; and
a plurality of instruments, each instrument having a perforation joining a first card and a second card, each of said first card and second card having an obverse and a reverse side, the first card having a hook opening and bearing on both its obverse and reverse sides indicia relating to a store coupon of a first predetermined value, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number;
wherein each instrument is hanging from the hook by its hook opening, and
wherein the obverse of each instrument faces in the first direction.

27. The assembly of claim 26 wherein, for each instrument, the first card has greater surface area than the second card.

28. The assembly of claim 27 wherein, for each instrument, the first card has more than double the surface area of the second card.

29. A method performed with respect to a hook protruding in a first direction; and a plurality of instruments, each instrument having a perforation joining a first card and a second card, each of said first card and second card having an obverse and a reverse side, the first card having a hook opening and bearing on both its obverse and reverse sides indicia relating to a store coupon of a first predetermined value, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number; the method comprising the steps of:
hanging a first one of the instruments on the hook by its hook opening, the instrument's obverse facing in the first direction; and
hanging a second one of the instruments on the hook by its hook opening, the instrument's obverse also facing in the first direction.

30. A method performed with respect to an instrument, the instrument having a perforation joining a first card and a second card, each of said first card and second card having an obverse and a reverse side, the first card bearing on both its obverse and reverse sides indicia relating to a store coupon of a first predetermined value, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number; the method comprising the steps of:
purchasing the instrument;
separating the first card from the second card at the perforation after purchase;
redeeming the first card for its first predetermined value in a purchase after the separating step; and
placing at least one long-distance telephone call for no greater than any unused portion of the second predetermined value;
the placing step further comprising dialing the toll-free access telephone number, and after the toll-free access telephone number is dialed, entering via dual-tone multifrequency tones the PIN code and a destination telephone number.

31. The method of claim 30 wherein the first card further comprises on its reverse a bar code relating to the first predetermined value, and wherein the step of redeeming the first card for its first predetermined value further comprises scanning the bar code on a bar code scanner.

32. The method of claim 30 wherein the placing step is performed more than once.

33. The method of claim 30 wherein the redeeming step is performed prior to performing the placing step.

34. Apparatus comprising an instrument, the instrument having a perforation joining a first card and a second card, each of said first card and second card having an obverse and a reverse side, the first card bearing on both its obverse and reverse sides indicia relating to a store coupon of a first predetermined value, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number.

35. The apparatus of claim 34 wherein the first card has greater surface area than the second card,

36. The apparatus of claim 35 wherein the first card has more than double the surface area of the second card.

37. An assembly comprising:
a rack defining a first direction; and
a plurality of instruments, each instrument having a perforation joining a first card and a second card, each of said first card and second card having an obverse and a reverse side, the first card bearing on both its obverse and reverse sides indicia relating to a store coupon of a first predetermined value, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number;
wherein each instrument is contained in the rack, and
wherein the obverse of each instrument faces in the first direction.

38. The assembly of claim 37 wherein, for each instrument, the first card has greater surface area than the second card.

39. The assembly of claim 38 wherein, for each instrument, the first card has more than double the surface area of the second card.

40. A method performed with respect to a rack defining a first direction; and
a plurality of instruments, each instrument having a perforation joining a first card and a second card, each of said first card and second card having an obverse and a reverse side, the first card bearing on both its obverse and reverse sides indicia relating to a store coupon of a first predetermined value, the second card having on both its obverse and reverse sides indicia relating to a prepaid long-distance telephone calling card, the second card having on its obverse indicia relating to a prepaid amount in a second predetermined value, the second card having on its reverse side a PIN code and a toll-free access telephone number; the method comprising the steps of:
placing a first one of the instruments in the rack, the instrument's obverse facing in the first direction; and
placing a second one of the instruments in the rack, the instrument's obverse also facing in the first direction.

41. A method performed with respect to an instrument, the instrument comprising a jacket and a card, each of said jacket and card having an obverse and a reverse side, the jacket having a hook opening and bearing on both its obverse and reverse sides indicia relating to a store coupon of a first predetermined value, the jacket having greater surface area than the card, the card having on both its obverse and reverse sides indicia relating to prepaid long-distance telephone calling, the card having on its obverse indicia relating to a prepaid amount in a second predetermined value, the card having on its reverse side a PIN code and a toll-free access telephone number, the card contained within the jacket with a portion of the card visible through a clear window area of the jacket; the method comprising the steps of:
hanging the instrument on a hook;
removing the instrument from the hook;
separating the card from the jacket;
redeeming jacket for its first predetermined value in a purchase after the separating step; and
placing at least one long-distance telephone call for no greater than any unused portion of the second predetermined value;
the placing step further comprising dialing the toll-free access telephone number, and after the toll-free access telephone number is dialed, entering via dual-tone multifrequency tones the PIN code and a destination telephone number.

42. The method of claim 41 wherein the jacket further comprises on its reverse a bar code relating to the first predetermined value, and wherein the step of redeeming the jacket for its first predetermined value further comprises scanning the bar code on a bar code scanner.

43. The method of claim 41 wherein the placing step is performed more than once.

44. The method of claim 41 wherein the redeeming step is performed prior to performing the placing step.

45. Apparatus comprising an instrument, the instrument comprising a jacket and a card, each of said jacket and card having an obverse and a reverse side, the jacket having a hook opening and bearing on both its obverse and reverse sides indicia relating to a store coupon of a first predetermined value, the jacket having greater surface area than the card, the card having on both its obverse and reverse sides indicia relating to prepaid long-distance telephone calling, the card having on its obverse indicia relating to a prepaid amount in a second predetermined value, the card having on its reverse side a PIN code and a toll-free access telephone number, the card contained within the jacket with a portion of the card visible through a clear window area of the jacket.

46. The apparatus of claim 45 wherein the jacket has more than double the surface area of the second card.

47. An assembly comprising:
a hook protruding in a first direction; and
a plurality of instruments, each instrument comprising a jacket and a card, each of said jacket and card having an obverse and a reverse side, the jacket having a hook opening and bearing on both its obverse and reverse sides indicia relating to a store coupon of a first predetermined value, the jacket having greater surface area than the card, the card having on both its obverse and reverse sides indicia relating to prepaid long-distance telephone calling, the card having on its obverse indicia relating to a prepaid amount in a second predetermined value, the card having on its reverse side a PIN code and a toll-free access telephone number, the card contained within the jacket with a portion of the card visible through a clear window area of the jacket;
wherein each instrument is hanging from the hook by its hook opening, and
wherein the obverse of each instrument faces in the first direction.

48. The assembly of claim 47 wherein, for each instrument, the first card has more than double the surface area of the second card.

49. A method performed with respect to a hook protruding in a first direction; and a plurality of instruments, each instrument comprising a jacket and a card, each of said jacket and card having an obverse and a reverse side, the jacket having a hook opening and bearing on both its obverse and reverse sides indicia relating to a store coupon of a first predetermined value, the jacket having greater surface area than the card, the card having on both its obverse and reverse sides indicia relating to prepaid long-distance telephone calling, the card having on its obverse indicia relating to a prepaid amount in a second predetermined value, the card having on its reverse side a PIN code and a toll-free access telephone number, the card contained within the jacket with a portion of the card visible through a clear window area of the jacket; the method comprising the steps of:
hanging a first one of the instruments on the hook by its hook opening, the instrument's obverse facing in the first direction; and
hanging a second one of the instruments on the hook by its hook opening, the instrument's obverse also facing in the first direction.

50. A method performed with respect to an instrument, the instrument comprising a jacket and a card, each of said jacket and card having an obverse and a reverse side, the jacket having a hook opening and bearing on both its obverse and reverse sides indicia relating to a store coupon of a first predetermined value, the jacket having greater surface area than the card, the card having on both its obverse and reverse sides indicia relating to prepaid long-distance telephone calling, the card having on its obverse indicia relating to a prepaid amount in a second predetermined value, the card having on its reverse side a PIN code and a toll-free access telephone number, the card contained within the jacket with a portion of the card visible through a clear window area of the jacket; the method comprising the steps of:
purchasing the instrument;
separating the jacket from the card after purchase;
redeeming the jacket for its first predetermined value in a purchase after the separating step; and
placing at least one long-distance telephone call for no greater than any unused portion of the second predetermined value;
the placing step further comprising dialing the toll-free access telephone number, and after the toll-free access telephone number is dialed, entering via dual-tone multifrequency tones the PIN code and a destination telephone number.

51. The method of claim 50 wherein the jacket further comprises on its reverse a bar code relating to the first predetermined value, and wherein the step of redeeming the jacket for its first predetermined value further comprises scanning the bar code on a bar code scanner.

52. The method of claim 50 wherein the placing step is performed more than once.

53. The method of claim 50 wherein the redeeming step is performed prior to performing the placing step.

54. Apparatus comprising an instrument, the instrument comprising a jacket and a card, each of said jacket and card having an obverse and a reverse side, the jacket having a hook opening and bearing on both its obverse and reverse sides indicia relating to a store coupon of a first predetermined value, the jacket having greater surface area than the card, the card having on both its obverse and reverse sides indicia relating to prepaid long-distance telephone calling, the card having on its obverse indicia relating to a prepaid amount in a second predetermined value, the card having on its reverse side a PIN code and a toll-free access telephone number, the card contained within the jacket with a portion of the card visible through a clear window area of the jacket.

55. The apparatus of claim 54 wherein the jacket has more than double the surface area of the card.

56. An assembly comprising:
a rack defining a first direction; and
a plurality of instruments, each instrument comprising a jacket and a card, each of said jacket and card having an obverse and a reverse side, the jacket having a hook opening and bearing on both its obverse and reverse sides indicia relating to a store coupon of a first predetermined value, the jacket having greater surface area than the card, the card having on both its obverse and reverse sides indicia relating to prepaid long-distance telephone calling, the card having on its obverse indicia relating to a prepaid amount in a second predetermined value, the card having on its reverse side a PIN code and a toll-free access telephone number, the card contained within the jacket with a portion of the card visible through a clear window area of the jacket;
wherein each instrument is contained in the rack, and
wherein the obverse of each instrument faces in the first direction.

57. The assembly of claim 56 wherein, for each instrument, the jacket has more than double the surface area of the card.

58. A method performed with respect to a rack defining a first direction; and a plurality of instruments, each instrument comprising a jacket and a card, each of said jacket and card having an obverse and a reverse side, the jacket having a hook opening and bearing on both its obverse and reverse sides indicia relating to a store coupon of a first predetermined value, the jacket having greater surface area than the card, the card having on both its obverse and reverse sides indicia relating to prepaid long-distance telephone calling, the card having on its obverse indicia relating to a prepaid amount in a second predetermined value, the card having on its reverse side a PIN code and a toll-free access telephone number, the card contained within the jacket with a portion of the card visible through a clear window area of the jacket; the method comprising the steps of:
placing a first one of the instruments in the rack, the instrument's obverse facing in the first direction; and
placing a second one of the instruments in the rack, the instrument's obverse also facing in the first direction.
